(19) United States
(12) Patent Application Publication
(10) Pub. No.: US 2025/0003245 A1
(43) Pub. Date: Jan. 2, 2025

(54) FRAME FOR ATTACHING A VEHICLE COVER

(71) Applicant: SUREBASE, LLC, Austin, TX (US)

(72) Inventor: Mark Chung, Austin, TX (US)

(21) Appl. No.: 18/758,710

(22) Filed: Jun. 28, 2024

Related U.S. Application Data
(63) Continuation of application No. 63/523,875, filed on Jun. 28, 2023.

(51) Int. Cl. E04H 6/04; B60J 11/04

(52) U.S. Cl. CPC E04H 6/04; B60J 11/04

(57) ABSTRACT

A frame for attaching a vehicle cover is disclosed. The frame includes first poles and second poles placed on the ground with the first poles acting as parallel poles and the second poles acting as orthogonal poles. The first poles position at the sides of a vehicle and the second poles position underneath wheels of the vehicle. The second poles utilize the curvature of the wheels and remain underneath the wheels. The first poles and the second poles are positioned perpendicularly to each other and connect via connectors. The frame includes a vehicle cover attached to distal ends of the first poles allowing it to cover the vehicle all the way to the ground without leaving a gap under the vehicle.

The present application claims the benefit of U.S. Provisional Application No. 63/523,875, filed Jun. 28, 2023; all of which is incorporated herein by reference.

### FIELD OF THE INVENTION

The present invention relates generally to a vehicle accessory. More specifically, the present invention relates to a frame for attaching a vehicle cover.

### BACKGROUND OF THE INVENTION

Vehicle covers are commonly used accessories for protecting vehicles from various elements such as dust, rain, snow, sunlight, etc. Most of the vehicle covers rely on elastic bands or straps to secure to the bottom edge of the vehicle cover around the vehicle.

Several vehicle covers for covering vehicles have been disclosed in the past. One such example is disclosed in a U.S. Pat. No. 6,516,822, entitled “Portable canopy for use with motor vehicles” (“the '822 Patent”). The '822 Patent discloses a canopy support assembly comprising two major sections: a drive-on anchoring assembly and a canopy support assembly. The anchoring assembly provides a device wherein a vehicle tire can be driven thereon thereby preventing movement of the assembly. Pivotally attached to the anchoring assembly is the canopy support for at least three telescoping poles. The support assembly can be pivoted onto the anchoring assembly for storage purposes. The pole support member of the support assembly can be pivoted to vary the parallel angle of the upstanding supports for the poles to accommodate different canopy sizes and shapes depending upon the specific application. In use, pairs of the assemblies will be used, one under each front or rear tire to provide a canopy for recreational use or a cover when, for example, one is working on a vehicle engine.

Another example is disclosed in a U.S. Pat. No. 10,895,092, entitled “Tire anchoring system” (“the '092 Patent”). The '092 Patent discloses a tire anchoring system having at least one anchoring assembly including a first bracket and a second bracket. The first bracket has a first bar and a second bar extending parallel to each other, and a first intermediate bar connecting the first bar and the second bar to define a first pocket dimensioned to engage at least a portion of a first tire. The second bracket has a third bar and a fourth bar extending parallel to each other, and a second intermediate bar connecting the third bar and fourth second bar to define a second pocket dimensioned to engage at least a portion of a second tire. A tensioning linkage connects the first bracket and the second bracket.

Another example is disclosed in a U.S. Pat. No. 10,801,228, entitled “Flood protection device” (“the '228 Patent”). The '228 Patent discloses a flood protection device comprising at least one base, at least one telescoping pole installed in each corner of base, a heavy-duty flexible material bag to cover at least one item placed on base and at least one locking unit comprising locking seal and button lock to seal bag. To cover the item using the device, first the item is placed on base. Then the poles are installed on the base to support the bag. After covering the item using bag, the locking seal and button lock are closed to seal the bag. The height of poles is adjustable to create sufficient space for item to be placed. The bag protects the item placed inside the device from flood and avoids any damage of it during flood and storm.

Yet another example is disclosed in a United States Publication No. 20190106902, entitled “Automatically Retractable Vehicle Cover” (“the '902 Publication”). The '902 Publication discloses a retractable vehicle cover including a collapsible cover, a mounting bracket, a first powered shaft, a second powered shaft, a retractable mechanism, a control module, a monitoring module, a wireless communication module, and at least one power supply. The collapsible cover is rotatably connected to the mounting bracket by the first powered shaft and the second powered shaft. The retractable mechanism allows the collapsible cover to automatically retract and deploy. The mounting bracket can be permanently or temporarily deployed. If temporarily deployed, a pair of wheel chocks utilizes the weight of the vehicle to secure the mounting bracket to the vehicle. The control module receives signals from the wireless communication module and accordingly controls the monitoring module. Finally, the monitoring module allows a user to remotely monitor the collapsible cover. The control module, the monitoring module, the wireless communication module are powered by at least one power supply.

Although the above discussed disclosures are useful, they have few problems. For instance, most of the vehicle covers are made of a lightweight material that can easily be dislodged or blown away by strong winds. Further, most of the vehicle covers have no means to secure the cover reliably to the vehicle other than with ineffective elastic bands or clumsy straps. Without a support system to hold it in place, the cover often does not sufficiently cover or protect the vehicle, with most covers leaving a gap under the car.

Therefore, there is a need in the art to provide a reliable and durable frame or a system that can safely secure a vehicle cover in place so that it does not get dislodged easily.

### SUMMARY

It is an object of the present subject matter to provide a frame that avoids the drawbacks of known vehicle covers and support mechanisms.

It is another object of the present subject matter to provide a frame that allows attaching a vehicle cover over a vehicle without leaving a gap under the vehicle.

In order to overcome one or more objects, the present subject matter presents a frame for attaching a vehicle cover. The frame includes first poles and second poles placed on the ground with the first poles acting as parallel poles and the second poles acting as orthogonal poles. The first poles position at the sides of a vehicle and the second poles position underneath wheels of the vehicle. The second poles utilize the curvature of the wheels and remain underneath the wheels. The first poles and the second poles are positioned perpendicularly to each other and connect via connectors. The frame includes a vehicle cover attached to distal ends of the first poles allowing it to cover the vehicle all the way to the ground without leaving a gap under the vehicle.

In one advantageous feature of the present subject matter, the frame presents a unique way to secure a protective cover on the vehicle.

In another advantageous feature of the present subject matter, the frame attaches or takes support from the wheels of the vehicle, and acts as a base to which the vehicle cover can be secured, all the way to the ground without leaving a gap under the vehicle.

The features and advantages of the subject matter here will become more apparent in light of the following detailed description of selected embodiments, as illustrated in the accompanying figures. As will be realized, the subject matter disclosed is capable of modifications in various respects, all without departing from the scope of the subject matter. Accordingly, the drawings and the description are to be regarded as illustrative in nature.

Additional support structures could be attached to base frame; such as frames at the front and back of the vehicle that can provide further support to the covering.

### BRIEF DESCRIPTION OF THE DRAWINGS

A more complete understanding of the invention and the many attendant advantages thereof will be readily appreciated as the same becomes better understood by reference to the following detailed description, when considered in connection with the accompanying drawings wherein:

FIG. 1 illustrates an environment in which a frame for attaching a vehicle cover implements, in accordance with one embodiment of the present subject matter;

FIG. 2 illustrates a perspective view of the frame, in accordance with one embodiment of the present subject matter;

FIGS. 3 and 4 illustrate a first pole and a second pole, respectively of the frame, in accordance with one embodiment of the present subject matter;

FIG. 5 illustrates a top view of a schematic diagram showing alignment of wheels with the frame, in accordance with another embodiment of the present subject matter;

FIGS. 6A and 6B illustrate a perspective view and a top view, respectively of a vehicle positioning over the frame, in accordance with one embodiment of the present subject matter;

FIG. 7 illustrates an environment in which a frame implements, in accordance with another embodiment of the present subject matter; and

FIG. 8 illustrates a vehicle cover placed over the frame, in accordance with one embodiment of the present subject matter.

### DETAILED DESCRIPTION

The following detailed description set forth below in connection with the appended drawings is intended as a description of exemplary embodiments in which the presently disclosed subject matter may be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed frame. However, it will be apparent to those skilled in the art that the presently disclosed subject matter may be practiced without these specific details. In some instances, well-known structures and devices are shown in functional or conceptual diagram form in order to avoid obscuring the concepts of the presently disclosed frame.

In the present specification, an embodiment showing a singular component should not be considered limiting. Rather, the subject matter preferably encompasses other embodiments including a plurality of the same component, and vice-versa, unless explicitly stated otherwise herein. Moreover, the applicant does not intend for any term in the specification to be ascribed an uncommon or special meaning unless explicitly set forth as such. Further, the present subject matter encompasses present and future known equivalents to the known components referred to herein by way of illustration.

Although the present subject matter provides a description of a frame, it is to be further understood that numerous changes may arise in the details of the embodiments of the frame. It is contemplated that all such changes and additional embodiments are within the spirit and true scope of this disclosure.

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure.

The present subject matter discloses a frame for attaching a vehicle cover. The frame includes first poles and second poles placed on the ground with the first poles acting as parallel poles and the second poles acting as orthogonal poles. The first poles position at the sides of a vehicle and the second poles position underneath wheels of the vehicle. The second poles utilize the curvature of the wheels and remain underneath the wheels. The first poles and the second poles are positioned perpendicularly to each other and connect via connectors. The frame includes a vehicle cover attached to distal ends of the first poles allowing it to cover the vehicle all the way to the ground without leaving a gap under the vehicle.

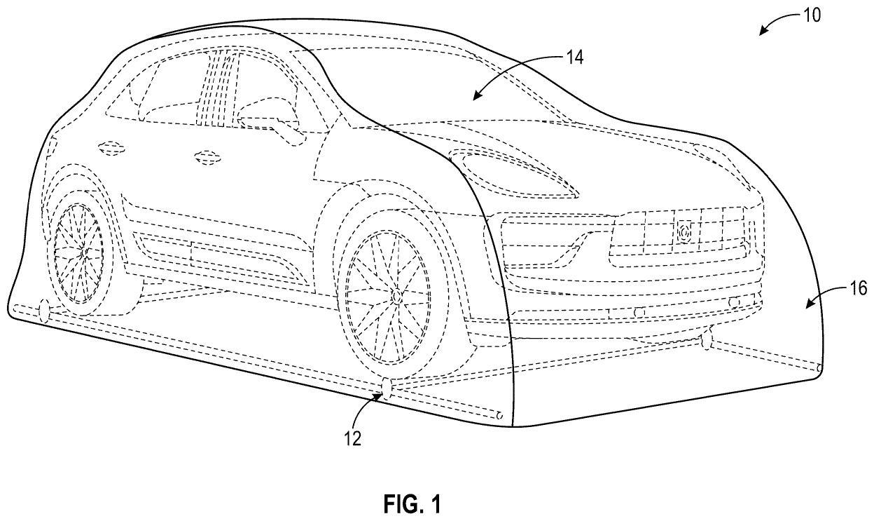

Various features and embodiments of a frame are explained in conjunction with the description of FIGS. 1-8.

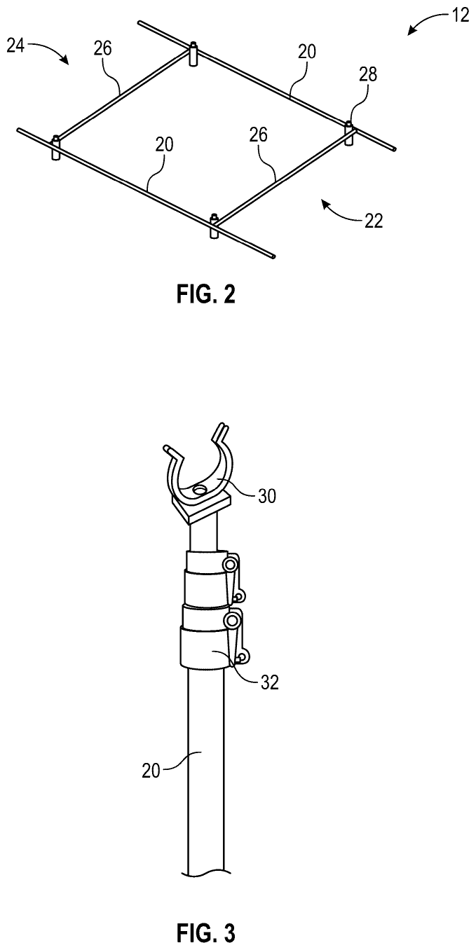

FIG. 1 shows an environment 10 of a frame 12 for covering a vehicle 14 using a vehicle cover 16, in accordance with one embodiment of the present subject matter. Here, vehicle 14 includes a car, jeep, bus, truck, any land, air or water-based vehicle. FIG. 2 shows a perspective view of frame 12, in accordance with one embodiment of the present subject matter. Frame 12 is made of a metal, hard plastic, wood or any other suitable material. Frame 12 includes a pair of first poles 20. First poles 20 indicate elongated poles placed in parallel to each other at a distance on the ground. In one example, first poles 20 are placed at a distance matching the width of vehicle 14. Each of first poles 20 includes a first end 22 and a second end 24 indicating a front end and a rear end, respectively of first pole 20 and/or vehicle 14.

Further, frame 12 includes a pair of second poles 26. Second poles 26 position parallel at a distance from one another on the ground. As can be seen from FIG. 2, second poles 26 position perpendicularly to first poles 20. Here, first poles 20 act as parallel poles and second poles 26 act as orthogonal poles. In accordance with one embodiment, frame 12 includes connectors 28 for connecting first poles 20 and second poles 26. Connectors 28 come in a variety of forms and sizes and help to connect first poles 20 and second poles 26. In one example, connectors 28 include clamps or magnetic clasps or any other connecting components. When connected, first poles 20 and second poles 26 form a H-shaped configuration.

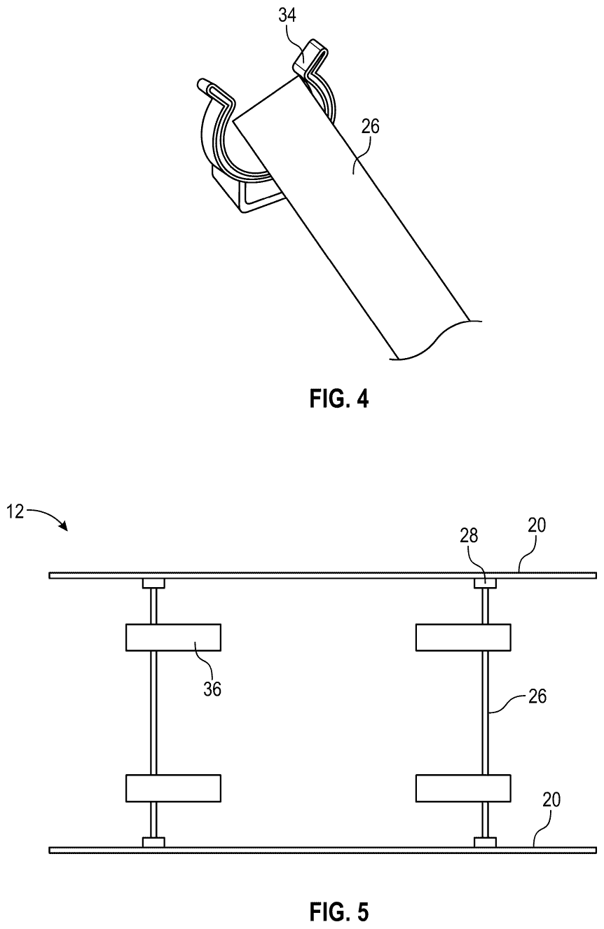

In one example, first pole 20 includes a telescopic pole or extension pole, as shown in FIG. 3. Here, first pole 20 includes locking members 30 capable of locking or adjusting the length of first pole 20. Further, first pole 20 includes a first locking connector 32 at one or both ends. In one example, first locking connector 32 helps to connect second pole 26 to first pole 20. Optionally, second pole 26 includes a second locking connector 34, as shown in FIG. 4. Second locking connector 34 helps to connect second pole 26 to first pole 20.

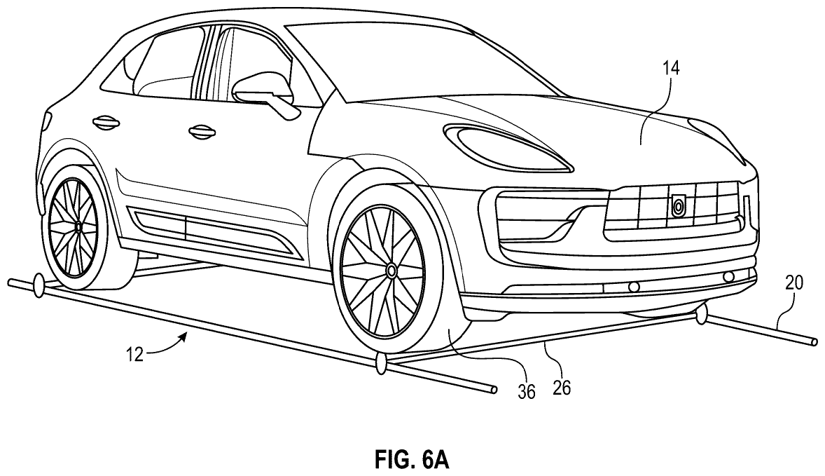

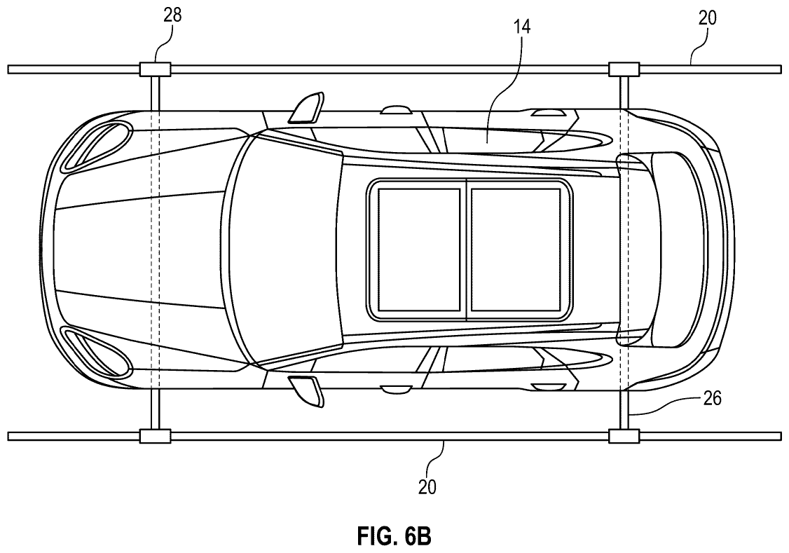

In accordance with the present subject matter, first poles 20 and second poles 26 position such that wheels 36 of vehicle 14 align with second poles 26. FIG. 5 shows a top view schematic diagram indicating the alignment of wheels 36 with frame 12. Further, FIGS. 6A and 6B show a perspective view and a top view, respectively of vehicle 14 positioning with respect to frame 12, in accordance with one embodiment of the present subject matter. As can be seen, frame 12 positions underneath vehicle 14 just adjacent to wheels 36 to remain in place. In other words, frame 12 utilizes wheels 36 of vehicle 14 as anchor points and form a sturdy base underneath and on the perimeter of vehicle 14.

Referring back to FIG. 1, operation of frame 12 to attach vehicle cover 16 is explained, in accordance with one embodiment of the present subject matter. At first, first poles 20 are positioned adjacent to wheels 36. Subsequently, second poles 26 are connected to first poles 20. Here, second poles 26 position underneath wheels 36 utilizing the curvature of wheels outer circumference and connect to first poles 20 via connectors 28. Connectors 28 ensure first poles 20 and second poles 26 remain securely attached to each other and provide a stable base for vehicle cover 16. This results in a stable and sturdy frame 12 to which vehicle cover 16 can affix securely. Further, vehicle cover 16 is secured to one distal end of first poles 20 say, at first end and drawn all the way over vehicle 14 and secured to second end of first poles 20 without leaving a gap under vehicle 14. Vehicle cover 16 is made of a suitable flexible material to stretch and secure at distal ends of first poles 20. As second poles 26 position underneath wheels 36, frame 12 remains in place at all times.

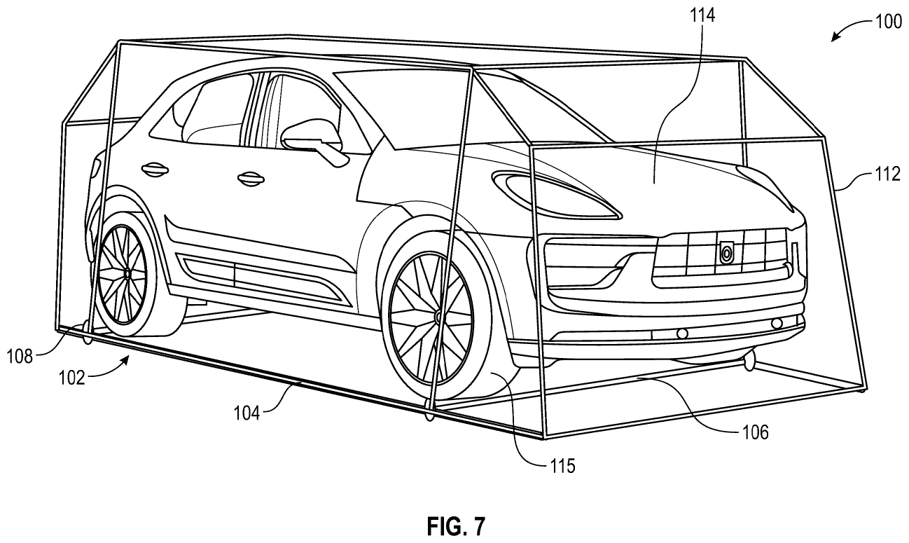

Now referring to FIG. 7, an environment 100 in which a frame 102 implements is explained, in accordance with another embodiment of the present subject matter. Here, frame 102 includes first poles 104. First poles 104 indicate elongated poles, similar to first poles 20, explained above. Further, frame 102 includes second poles 106. Second poles 106 indicate elongated poles, similar to second poles 26, explained above. As presented above, first poles 104 act as parallel poles and second poles 106 act as orthogonal poles. Further, frame 102 includes connectors 108 to connect first poles 104 and second poles 106.

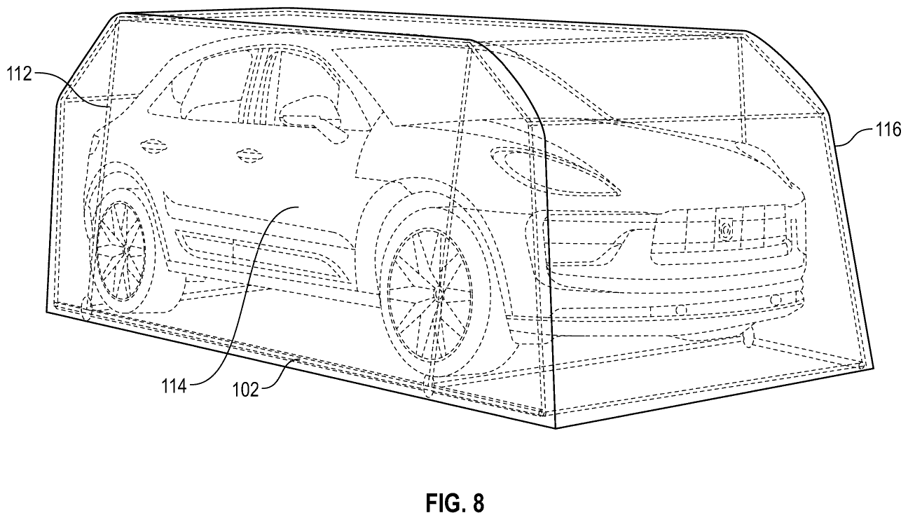

In the present embodiment, frame 102 includes extended poles 112. Extended poles 102 extend from first poles 104 facing upwards. In one example, extended poles 112 extend such that a vehicle 114 is housed within, as shown in FIG. 7. Frame 102 positions underneath vehicle 114 utilizing wheels 115 as anchor points and forms a sturdy base and on the perimeter of vehicle 114. Further, frame 102 includes a vehicle cover 116. In the present embodiment, vehicle cover 116 is secured to one distal end of first poles 104 and drawn over extended poles 112 and secured at the other end of first poles 104 without leaving a gap under vehicle 114, as shown in FIG. 8.

In another embodiment, the frame comes as a part of a vehicle camper tent (not shown). Here, the frame is provided as an attachment frame for a tent that is attached to the vehicle. In one example, the frame attached at the back of the vehicle. When needed, the frame stretches/expands and lowers such that the vehicle can position over the frame. Subsequently, the user of the vehicle attaches a vehicle cover to the frame to cover the vehicle.

The presently disclosed frame provides several advantages over prior art. For example, the frame is positioned under the wheels of the vehicle. Once in place, the frame is not easily dislodged or moved. The frame is portable and easy to assemble and disassemble. The frame helps to attach the vehicle cover to a stable base i.e., the frame placed underneath the wheels to enhance the vehicle cover's ability to protect the vehicle. The frame provides superior protection for the vehicle, as it allows the vehicle cover to go all the way to the ground and sealing it to the frame without leaving any gap under the vehicle. This ensures debris or even small animals can go through the vehicle cover. When not in use, the frame can be uninstalled and stored in a compact storage bag and can be transported in a trunk of the vehicle. The frame can be used in a variety of environments such as outdoor parking lots, garages or carports.

A person skilled in the art appreciates that the frame can come in a variety of shapes and sizes depending on the need and comfort of the user. Further, many changes in the design and placement of components may take place without deviating from the scope of the presently disclosed frame.

In the above description, numerous specific details are set forth such as examples of some embodiments, specific components, devices, methods, in order to provide a thorough understanding of embodiments of the present subject matter. It will be apparent to a person of ordinary skill in the art that these specific details need not be employed, and should not be construed to limit the scope of the subject matter.

In the development of any actual implementation, numerous implementation-specific decisions must be made to achieve the developer's specific goals, such as compliance with system-related and business-related constraints. Such a development effort might be complex and time-consuming, but may nevertheless be a routine undertaking of design, fabrication, and manufacture for those of ordinary skill. Hence as various changes could be made in the above constructions without departing from the scope of the invention, it is intended that all matter contained in the above description or shown in the accompanying drawings shall be interpreted as illustrative and not in a limiting sense.

It will be apparent to those skilled in the art that various modifications and variations can be made in the present disclosure without departing from the scope or spirit of the disclosure. Other embodiments of the disclosure will be apparent to those skilled in the art from consideration of the specification and practice of the disclosure disclosed herein. It is intended that the specification and examples be considered as exemplary only, with a true scope and spirit of the disclosure.

I claim:

1. I claim all of the above subject matter.
